(19) United States
(12) Patent Application Publication
(10) Pub. No.: US 2019/0355004 A1
(43) Pub. Date: Nov. 21, 2019

(54) METHOD AND SYSTEM FOR PREDICTING FUTURE SPENDING

(71) Applicant: Mastercard International Incorporated, Purchase, NY (US)

(72) Inventors: Tim M. WATKINS, Saint Charles, MO (US); Alvin LEE, Redwood City, CA (US); Marimuthu VELLINGIRI, Belmont, CA (US); Sethupathi THANGAMUTHU, Belmont, CA (US); Ravikumar KUPPUSAMY, Belmont, CA (US)

(73) Assignee: Mastercard International Incorporated, Purchase, NY (US)

(21) Appl. No.: 15/985,169

(22) Filed: May 21, 2018

(51) Int. Cl. G06Q 30/02; H04L 29/08

(52) U.S. Cl. CPC G06Q 30/0205; H04L 67/306; G06Q 30/0201; G06Q 30/0203

(57) ABSTRACT

A method for predicting future spending can include receiving, by processing circuitry, at least one data point of a user, wherein the at least one data point includes at least one transaction attribute of at least one user transaction, analyzing the at least one data point, determining at least one peer group of the user based in part on the at least one data point of the user, comparing the at least one data point of the user with data associated with the at least one peer group of the user, and predicting at least one future spending activity of the user.

### BACKGROUND

The disclosed subject matter relates to methods, systems, networks, and media for budgeting and spending management.

With the rise of credit card spending and electronic purchases, an increasing number of financial institutions are able to determine the spending activity of their members. However, current financial budgeting tools offered by such financial institutions are highly manual and require customer data and/or customer input to analyze past spending activity. Some financial institutions provide historical transaction data analytics for customers to set and track spending against a customer's preset goals, but do not provide data analysis to predict future spending or to formulate future budgets.

Accordingly, there exists a need for methods and systems for analyzing user spending data, to predict future spending based on analysis of past spending, and/or to formulate budgets based on such spending analysis.

### SUMMARY

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages and in accordance with the purpose of the disclosed subject matter, as embodied and broadly described, a method for predicting future spending is disclosed. The method can include receiving, by processing circuitry, at least one data point of a user, wherein the at least one data point includes at least one transaction attribute of at least one user transaction. The method can include analyzing, by the processing circuitry, the at least one data point, determining, by the processing circuitry, at least one peer group of the user based in part on the at least one data point of the user comparing, by the processing circuitry, the at least one data point of the user with data associated with the at least one peer group of the user, and predicting, by the processing circuitry, based on a comparison between the at least one peer group of the user and the at least one data point of the user, at least one future spending activity of the user.

For purpose of illustration and not limitation, the method can include the at least one data point comprising at least one user answer to at least one user-directed question.

For purpose of illustration and not limitation, the method can include wherein analyzing, by the processing circuitry, the at least one data point, further comprises identifying, by the processing circuitry, a location of the at least one user transaction and determining, by the processing circuitry, a distance from the location of the at least one user transaction to a user's home.

For purpose of illustration and not limitation, the method can include wherein analyzing, by the processing circuitry, the at least one data point, further comprises identifying, by the processing circuitry, at least one merchant associated with the at least one user transaction.

For purpose of illustration and not limitation, the method can include determining, by the processing circuitry, based on the at least one data point of the user and based on results of analyzing the at least one data point, a user profile. The method can further include comparing, by the processing circuitry, the user profile to user profiles of other users within the at least one peer group of the user, and determining a spending habits comparison of the user profile in relation to the user profiles of other users within the at least one peer group of the user.

For purpose of illustration and not limitation, the method can include wherein the spending habits comparison comprises a percentile rank associated with the user, indicating an amount that the user spent on a certain type of product or category of merchant within a set time period, as compared to other users.

For purpose of illustration and not limitation, the method can include wherein predicting, by the processing circuitry, at least one future spending activity of the user, further comprises identifying, by the processing circuitry, at least one peer group of a user comprising previous user profiles of other users, and predicting, based on current user profiles of the other users within the at least one peer group of the user, at least one future spending activity of the user.

For purpose of illustration and not limitation, the method can include wherein the at least one future spending activity of the user includes a new category of spending or a new amount of spending.

For purpose of illustration and not limitation, the method can include wherein the at least one data point of the user comprises user demographic information.

In accordance with another aspect of the disclosed subject matter, a system for predicting future spending is disclosed.

For purpose of illustration and not limitation, the system can include processing circuitry configured to receive at least one data point of a user, wherein the at least one data point includes at least one transaction attribute of at least one user transaction, analyze the at least one data point, determine at least one peer group of the user based in part on the at least one data point of the user, compare the at least one data point of the user with data associated with the at least one peer group of the user, and predict, based on a comparison between the at least one peer group of the user and the at least one data point of the user, at least one future spending activity of the user.

For purpose of illustration and not limitation, the system can include wherein the at least one data point comprises at least one user answer to at least one user-directed question.

For purpose of illustration and not limitation, the processing circuitry can be further configured to identify a location of the at least one user transaction, and determine a distance from the location of the at least one user transaction to a user's home.

For purpose of illustration and not limitation, the processing circuitry can be further configured to identify at least one merchant associated with the at least one user transaction.

For purpose of illustration and not limitation, the processing circuitry can be further configured to determine, based on the at least one data point of the user and based on results of analyzing, by the processing circuitry, the at least one data point, a user profile. The processing circuitry can be further configured to compare the user profile to user profiles of other users within the at least one peer group of the user, and to determine a spending habits comparison of the user profile in relation to the user profiles of other users within the at least one peer group of the user.

For purpose of illustration and not limitation, the system can include wherein the spending habits comparison comprises a percentile rank associated with the user, indicating an amount that the user spent on a certain type of product or category of merchant within a set time period, as compared to other users.

For purpose of illustration and not limitation, the processing circuitry can be further configured to identify at least one peer group of a user comprising previous user profiles of other users, and to predict, based on current user profiles of the other users within the at least one peer group of the user, at least one future spending activity of the user.

For purpose of illustration and not limitation, the system can include wherein the at least one future spending activity of the user includes a new category of spending or a new amount of spending.

For purpose of illustration and not limitation, the system can include wherein the at least one data point of the user comprises user demographic information.

It is to be understood that both the foregoing general description and the following detailed description are exemplary and are intended to provide further explanation of the disclosed subject matter claimed.

The accompanying drawings, which are incorporated in and constitute part of this specification, are included to illustrate and provide a further understanding of the disclosed subject matter. Together with the description, the drawings serve to explain the principles of the disclosed subject matter.

### BRIEF DESCRIPTION OF THE DRAWINGS

FIG. 1 is a diagram illustrating a representative payment network according to an illustrative embodiment of the disclosed subject matter.

FIG. 2 is a diagram illustrating a system for predicting future spending according to an illustrative embodiment of the disclosed subject matter.

FIG. 3A is a diagram illustrating analysis components of a system for predicting spending according to an illustrative embodiment of the disclosed subject matter.

FIG. 3B is a diagram illustrating analysis components of a system for predicting spending according to an illustrative embodiment of the disclosed subject matter.

FIG. 3C is a diagram illustrating analysis components of a system for predicting spending according to an illustrative embodiment of the disclosed subject matter.

FIG. 4 is a block diagram illustrating further details of a representative computer system according to an illustrative embodiment of the disclosed subject matter.

FIG. 5 is a flow chart illustrating a representative method, for predicting future spending, implemented according to an illustrative embodiment of the disclosed subject matter.

Throughout the drawings, the same reference numerals and characters, unless otherwise stated, are used to denote like features, elements, components or portions of the illustrated embodiments. Moreover, while the present disclosed subject matter will now be described in detail with reference to the figures, it is done so in connection with the illustrative embodiments.

### DETAILED DESCRIPTION

In accordance with the need for methods and systems for predicting future spending, the present disclosure provides methods and systems beyond previous budgeting tools by tracking spending activity and analyzing such activity, and, in conjunction with data from many sources, determining a peer group and/or groups to which a user might belong, and thereby predicting future spending activity of the user. Additionally and/or alternatively, the methods and systems disclosed herein can include various types of functionality to compare users to their peers based on spending activity and transmit, to the user, a comparison of their activity in relation to other users of their peer group or groups. An aspect of the present disclosure can include the ability to automatically configure a user's future budget based on predictive analysis, which can provide far more value to the consumer than current financial budgeting systems.

In some embodiments, the systems and methods disclosed herein can predict future spending by collecting, receiving, and/or storing data, such as historical transaction-level data associated with a user, via for example one or more enrolled cards via MasterPass (or any digital wallet). In some embodiments, the methods and systems disclosed herein can analyze data, for example, through categorization and correlation of transactions across various divisions by category (or type) of merchant, by specific merchant, by location and/or by period of time, to predict future spending based on previous spending activity (such as, for example, transaction history). In this manner, the systems and methods disclosed herein can enable the consumer to plan or estimate future spending based on the results of data analysis of their past spending. As an example, in some embodiments, the methods and systems disclosed herein can, for example receive data indicating that, for the past 2 years, a user never completed a transaction at a certain merchant, for example, Babies 'R Us. In this example embodiment, if the systems and methods disclosed herein begin receiving data indicating that the user is completing transactions at that certain merchant, again (i.e., Babies 'R Us), the methods and systems disclosed herein can predict, after analysis, that after a certain period of months or years, the user is likely to spend more on merchants like Toys 'R Us, or other merchants categorized as children-specific merchants.

Reference will now be made in detail to the various exemplary embodiments of the disclosed subject matter, exemplary embodiments of which are illustrated in the accompanying drawings. The structure and corresponding method of operation of the disclosed subject matter will be described in conjunction with the detailed description of the system.

The methods, systems, networks, and media presented herein can be used for predicting future spending activity.

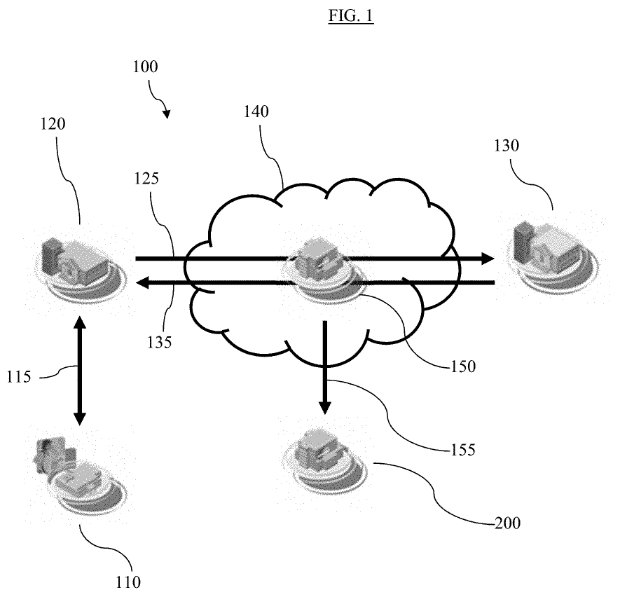

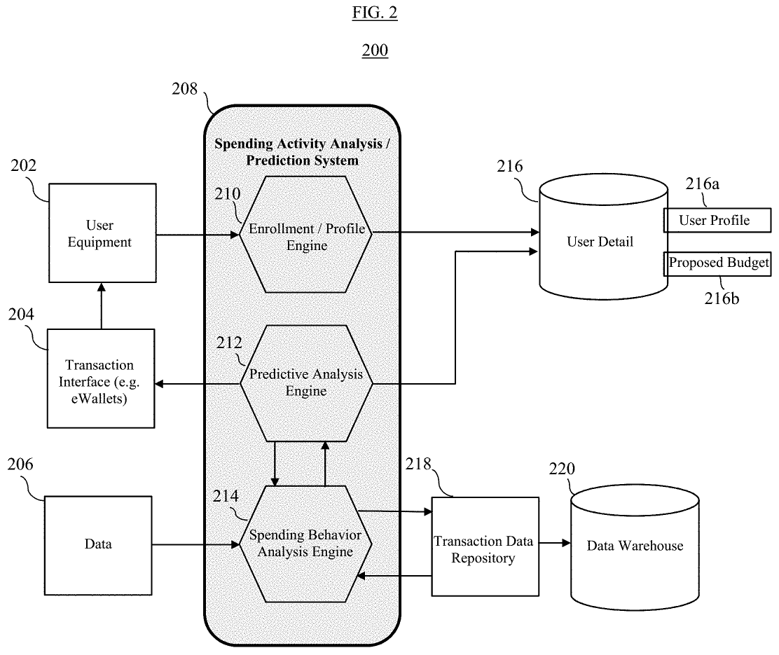

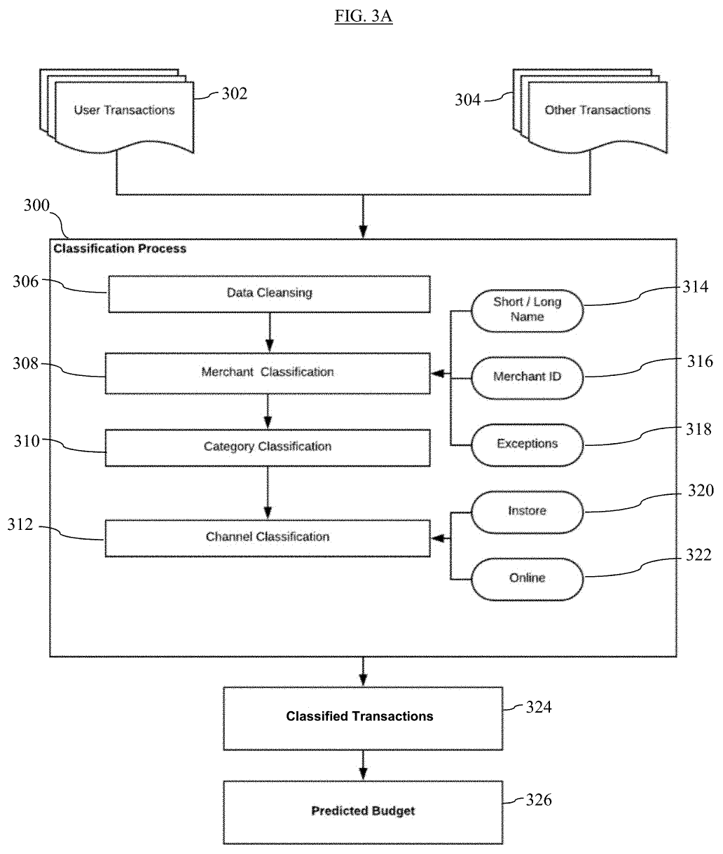

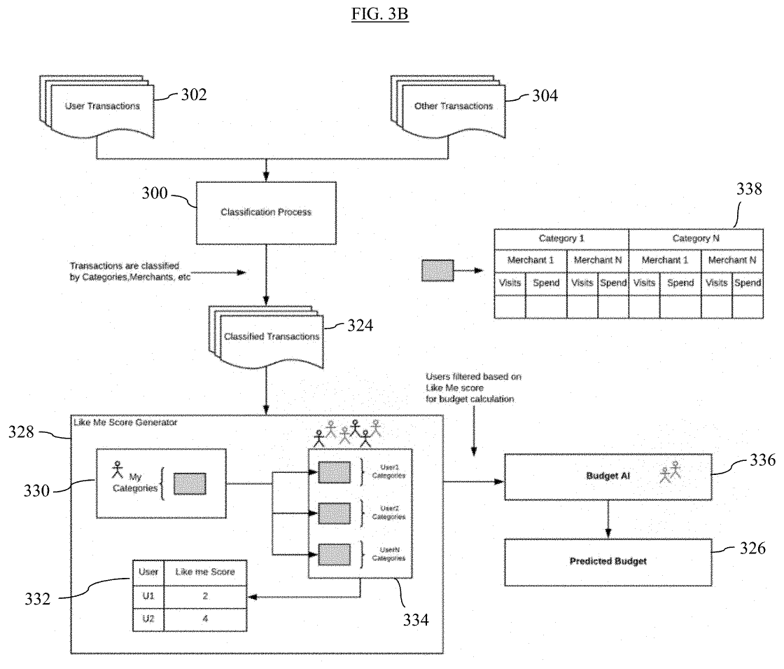

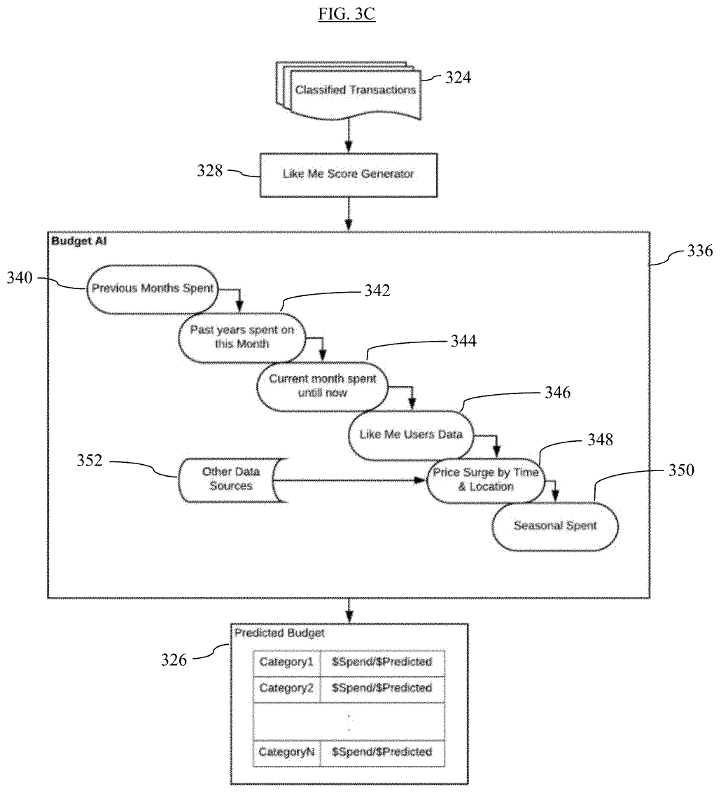

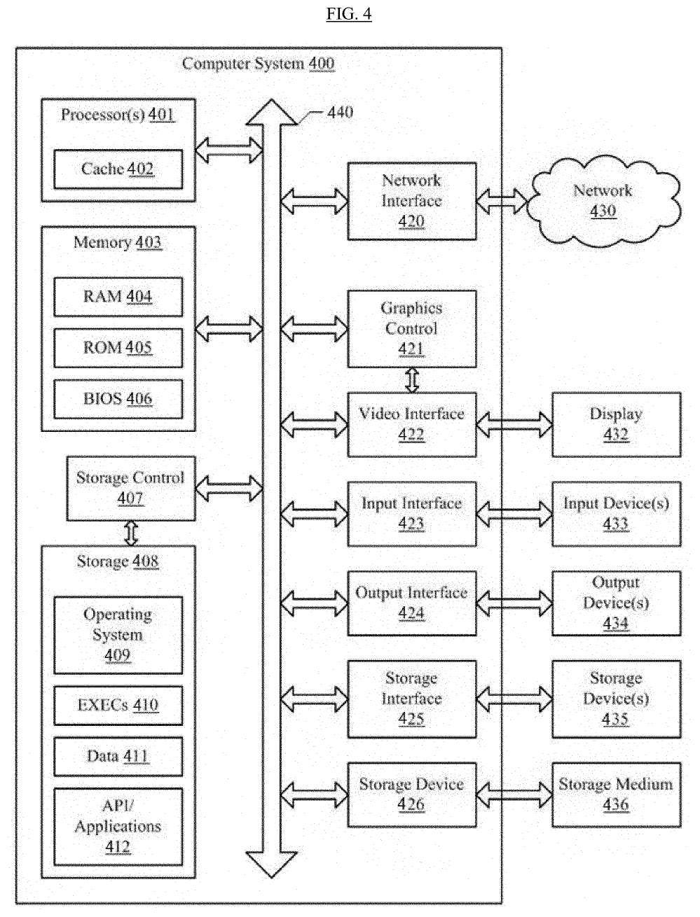

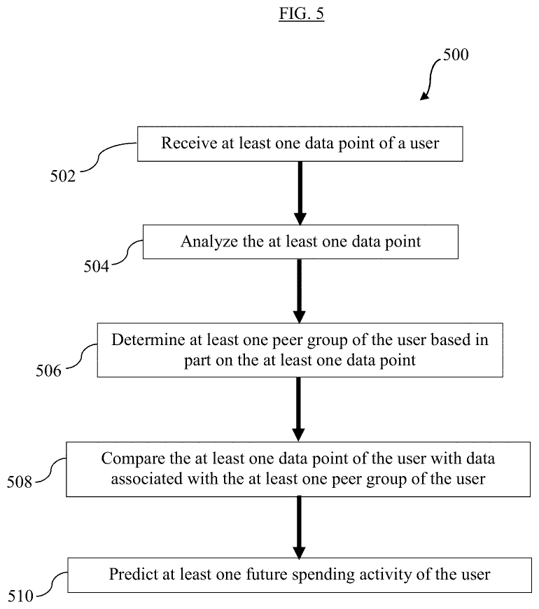

The accompanying figures, where like reference numerals refer to identical or functionally similar elements throughout the separate views, further illustrate various embodiments and explain various principles and advantages all in accordance with the disclosed subject matter. For purpose of explanation and illustration, and not limitation, an exemplary embodiment of a payment network for predicting future spending in accordance with the disclosed subject matter is shown in FIG. 1. FIG. 2 shows an exemplary block diagram of a system for predicting future spending in accordance with the disclosed subject matter. FIG. 3A is a diagram illustrating analysis components of a system for predicting spending according to an illustrative embodiment of the disclosed subject matter. FIG. 3B is a diagram illustrating analysis components of a system for predicting spending according to an illustrative embodiment of the disclosed subject matter. FIG. 3C is a diagram illustrating analysis components of a system for predicting spending according to an illustrative embodiment of the disclosed subject matter. FIG. 4 is a block diagram illustrating further details of a representative computer system according to an illustrative embodiment of the disclosed subject matter. FIG. 5 is a flow chart illustrating a representative method, for predicting future spending, implemented according to an illustrative embodiment of the disclosed subject matter.

While the present disclosed subject matter is described with respect to using methods, systems, networks, and media for predicting future spending, one skilled in the art will recognize that the disclosed subject matter is not limited to the illustrative embodiments.

FIG. 1 depicts a diagram illustrating a representative payment network 100 according to an illustrative embodiment of the disclosed subject matter. Payment network 100 can allow for payment transactions in which merchants and card issuers do not necessarily have a one-to-one relationship. The payment network 100, for example and without limitation a credit card payment system, can utilize an electronic payment network 140, such as the MasterCard® payment card system interchange network. The MasterCard® payment card system interchange network is a proprietary communications standard promulgated by MasterCard International Incorporated® based on the ISO 8583 message format for the exchange of financial transaction data between financial institutions that are customers of MasterCard International Incorporated. (MasterCard is a registered trademark of MasterCard International Incorporated located in Purchase, N.Y.)

As embodied herein, the payment network 100 for determining a discount amount for an electronic commerce transaction can include at least one merchant 110 connected to at least one electronic payment network 140, either directly or through an acquirer 120 via connection 115. At least one acquirer 120 can be connected to the electronic network 140, and each merchant 110 can be in communication with at least one acquirer 120 via the at least one payment network 140 or connection 115. At least one issuer 130 can be connected to the electronic network 140, and each acquirer 120 can be in communication with at least one issuer 130 via the electronic payment network 140.

For purpose of illustration and not limitation, in payment network 100, a financial institution, such as an issuer 130, can issue an account, such as a credit card account or a debit card account, to a cardholder (e.g., an individual consumer or a corporate or commercial customer), who can use the payment account card to tender payment for a purchase from a merchant 110 or to conduct a transaction at an ATM or website. To accept payment with the payment account card, merchant 110 can establish an account with a financial institution that is part of the financial payment system. This financial institution can be referred to as the “merchant bank” or the “acquiring bank,” or herein as “acquirer 120.” When a cardholder tenders payment for a purchase with a payment account card, the merchant, ATM, or website 110 can request authorization from acquirer 120 for the amount of the purchase. The request can be performed over the telephone, online via a website, or through the use of a point-of-sale terminal which can read the cardholder's account information from the magnetic stripe on the payment account card, from a smart card using contact pads, contactlessly from a near-field communication (NFC) device, or from manual entry and communicate electronically with the transaction processing computers of acquirer 120. Alternatively, acquirer 120 can authorize a third party to perform transaction processing on its behalf. In this case, the point-of-sale terminal can be configured to communicate with the third party. Such a third party can be referred to as a “merchant processor” or an “acquiring processor.”

As embodied herein, using payment network 140, the computers of acquirer 120 or the merchant processor can communicate information regarding payment card transactions with computers of the issuer 130. For example, and not limitation, information regarding payment card transactions can include an authorization request 125 and an authorization response 135. An authorization request 125 can be communicated from the computers of the acquirer 120 to the computers of issuer 130 to determine whether the cardholder's account is in good standing and whether the purchase is covered by the cardholder's available credit line or account balance. Based on these determinations, the authorization request 125 can be declined or accepted, and an authorization response 135 can be transmitted from the issuer 130 to the acquirer 120, and then to the merchant, ATM, or website 110. The authorization request 125 can include account information identifying the merchant, location information (e.g., an address of the merchant), and transaction information, as discussed herein. The authorization response 135 can include, among other things, a result of the determination that the transaction is approved or declined and/or information about the status of the payment card or payment account.

For example, and not limitation, at least one payment network server 150 can be connected to the electronic payment network 140 and configured to automatically capture the data representing a plurality of variables related to payment card transactions from the electronic payment network 140. As embodied herein, the payment network server 150 can be configured to only capture the data representing a plurality of variables related to payment card transactions with the permission of the cardholder. Additionally, the payment network server 150 can be configured to only capture the information regarding payment card transactions in accordance with applicable data privacy laws.

As embodied herein, system 200 for predicting future spending can be connected to the at least one payment network server 150 and can have access to data processed by that server, for example from the merchant 110, the acquirer 120, the issuer 130, and/or the electronic payment network 140.

As embodied herein, the system for predicting future spending 200 can include an interface for user access that is offered to users on the same platform on which they access information from the issuer 130 and/or from the acquirer 120 and/or it can include a separate interface for accessing information unique to the system for predicting future spending 200.

FIG. 2 depicts a block diagram illustrating a representative system 200 for predicting future spending.

As embodied herein, system 200 for predicting future spending can include Transaction Interface 204, Data source 206, Spending Activity Analysis/Prediction System 208, including Enrollment/Profile Engine 210, Predictive Analysis Engine 212, and Spending Behavior Analysis Engine 214, User Detail 216, including User Profile 216a and Proposed Budget 216b, Transaction Data Repository 218, and Data Warehouse 220, the system receiving data from and transmitting data to User Equipment 202.

As embodied herein, Spending Activity Analysis/Prediction System 208 can include the Enrollment/Profile Engine 210, a Predictive Analysis Engine 212, and a Spending Behavior Analysis Engine 214.

As embodied herein, the Spending Behavior Analysis Engine 214 can receive data from data source 206. In some embodiments, the Spending Behavior Analysis Engine 214 can contain a rules and analytics engine to track user spending activity, which can include metadata related to the time, location, merchant category, and SKU-level data indicating precise purchases, and other transaction activity data.

With reference to FIG. 3A, which provides a diagram illustrating analysis components of a system for predicting spending according to an illustrative embodiment of the disclosed subject matter, Spending Behavior Analysis Engine 214 can include a Classification Process System 300. The Classification Process System 300 can receive data regarding user transactions 302 and data regarding other users' transactions 304 from data source 206. The Classification Process System 300 can classify transactions, for example by identifying the merchant, category, and channel of commerce associated with transactions.

Classification Process System 300 can include Data Cleansing 306, which can normalize geographical data associated with transactions by, for example, correcting variations in the spelling or abbreviation of city or other place names associated with transactions, and by, for example, removing unique identifiers from transaction descriptions, which can include, for example, order numbers, confirmation numbers, such as flight confirmation or other reservation confirmation numbers, or other descriptive customer or account information.

The Classification Process System 300 can include Merchant Classification 308, which for example, can associate a transaction with a merchant name or abbreviation 314, a merchant ID 316, or can employ one or more exceptions 318. Exceptions 318 can include manual or automatic corrections to a merchant classification that correct default classifications that may be erroneous or misleading. For example, if a coffee shop is located within a hotel, a transaction at that coffee shop may include a default merchant classification identifying the hotel as the merchant. However, Classification Process System 300 can employ Exceptions 318, based on one or more identifiers in the transaction data, to override or change the merchant classification to indicate that the coffee shop is the merchant associated with the transaction.

Classification Process System 300 can include Category Classification 310, which can map a category assigned to the merchant, with the transaction. Merchants may be assigned one or more categories based on the type of goods or services they offer.

Classification Process System 300 can include Channel Classification 312, which can identify whether a transaction was conducted in-store/in-person or remotely, such as over the phone or internet Channel Classification 312 can distinguish between channels of transaction by, for example, using geographical data associated with the transaction and/or a “card present” flag that identifies whether a transaction was conducted with the payment card in the physical presence of the merchant or transaction location.

Classification Process System 300 can thereby produce Classified Transactions 324 for use in other processes performed by the Spending Behavior Analysis Engine 214 and the Predictive Analysis Engine 212, to create Predicted Budget 326.

With reference to FIG. 3B, which provides a diagram illustrating analysis components of a system for predicting spending according to an illustrative embodiment of the disclosed subject matter, Classified Transactions 324 can be further processed within the Spending Behavior Analysis Engine 214, by the Like Me Score Generator 328. Like Me Score Generator 328, within Spending Behavior Analysis Engine 214, can identify and select peer groups of a user. Classified Transactions 324 can be input to the Like Me Score Generator 328, which can employ one or both of a rules-based and data science model-based engine for analyzing user profiles. Statistics calculated by the Like Me Score Generator 328 can be based on User Categories 330, such as a frequency with which a user visits a particular merchant, a type of merchant, a merchant location, an average, maximum, or minimum amount that a user spends at one or more merchant, merchant type, or merchant location, and seasonal spending statistics of a user. Categories 330 can be classified by one or more of a number of visits or an amount spent, as depicted, for example, in Categories Chart 338. Classified Transactions 324 of users are analyzed based on various categories and compared at User Category Comparator 334 which employs a model to indicate how “alike” a particular user is to the transaction profile and spending patterns of other users. For a subject user, a Like Me Score 332 can be generated. Based on one or more Like Me Scores, as well as, for example, one or more of geography, payment card or other credit products, inferred user data, social media data made available to the system, and demographic data such as age, age group and/or gender, one or more peer groups may be determined. A higher or stronger Like Me Score 332 can be correlated with increased similarity between one or more users. Results of the Like Me Score Generator 328 can be further processed within the Spending Behavior Analysis Engine 214 and can be used by the Predictive Analysis Engine 212, for example in forming a Predicted Budget 326.

In some embodiments, the Spending Behavior Analysis Engine 214 can, as part of its analysis of user data, determine groups of peer users using aggregated user data, and group peer transaction activity to create bands. In some embodiments, the Spending Behavior Analysis Engine 214 can determine a user's spending habits in comparison to their peers. For example, a user can be informed that, compared to a peer group identified for the user, that user spends a certain percentage more or less than average on a certain item, type of transaction, or category of merchant. In some embodiments, the Spending Behavior Analysis Engine 214 can allow users to access peer group information. In some embodiments, users can access and review peer group information from User Equipment 202, and Spending Behavior Analysis Engine 214 can transmit information, so that it is accessible from User Equipment 202, that can include peer group statistics on spending and statistics related to a user's spending relative to certain peer groups, within certain categories. In some embodiments, a user can run specialized queries to see at a more granular level how their peers are spending, and the Spending Behavior Analysis Engine 214 can provide results based on user data compared to data of other users. For example, the Spending Behavior Analysis Engine 214 can allow a user can filter by location or merchant/merchant-type to retrieve information related to their spending relative to the spending of peer users. In this example, a user can retrieve information in the form of bands. For example, a user's query can return the result that the user is spending, in relation to peer users, 25% of what the average user spends on a certain merchant-type. Additionally and/or alternatively, a user can retrieve information in for the form of bands indicating that a certain number of peer users share, exceed, or do not exceed, a certain user statistic. For example, a user can retrieve a band result indicating that 10-50 peer users share a certain spending statistic with the user, or that 100+ peer users share, exceed, or do not exceed a certain spending statistic with the user.

As embodied herein, the Predictive Analytics Engine 212 can generate predictions for a user's future spending. In some embodiments, the Predictive Analytics Engine 212 can generate comparisons of the user's current spending to their past spending. For example, the Predictive Analytics Engine 212 can receive data from the Spending Behavior Analysis Engine 214, indicating that a user has, over the course of a month, begun making purchases at a particular merchant that tend to indicate a change in the user's life that can affect future spending. For example, a user might begin making weekly purchases of gasoline, when before the user had never purchased gasoline. The Spending Behavior Analysis Engine 214 can recognize that change and transmit that new data to the Predictive Analysis Engine 212. In some embodiments, the Predictive Analysis Engine 212 can, upon receiving that new data, perform one or more analysis steps to form a prediction of the user's future spending. For example, the Predictive Analysis Engine 212 can compare the user's new weekly spending on gasoline to that of other users with similar demographic information, such as geographic location and age. Additionally and/or alternatively, the Predictive Analysis Engine 212 can compare the user's new weekly spending on gasoline to other users having previous user profiles that are similar to those being identified as within that user's peer group, based on other transformed data from the Spending Behavior Analysis Engine 214. Using information related to those users' previous profiles, the Predictive Analysis Engine 212 can form predictions related to the user's future spending by adjusting the user's current spending by variances identified in the current spending of users whose previous profiles were previously similar to the user's current profile. For example, a comparison of previous user profiles to the current profiles of those users might show that when the user profiles of those users changed from reflecting no purchases of gasoline to reflecting weekly purchases of gasoline, their profiles also changed to reflect increased spending on restaurants, perhaps indicating that when users started driving, they started going out to more restaurants. Accordingly, the Predictive Analysis Engine 212 can predict that the user whose user profile recently started reflecting weekly purchases of gasoline will likely, within a certain time period determined by the Predictive Analysis Engine 212, begin to reflect increased spending on restaurants. In some embodiments, the Predictive Analysis Engine 212 can transmit data to user Detail 216 to update User Profile 216a. Additionally, and/or alternatively, the Predictive Analysis Engine 212 can transmit data to user Detail 216 to automatically update Proposed Budget 216b.

With reference to FIG. 3C, which provides a diagram illustrating analysis components of a system for predicting spending according to an illustrative embodiment of the disclosed subject matter, an example of a Budget Artificial Intelligence Tool (Budget AI) 336 within the Predictive Analysis Engine 212, is provided. For example, Budget AI 336 can receive Classified Transactions 324 and/or the output or outputs of the Like Me Score Generator 328 to perform analysis processes and methods to form a Predicted Budget 326. Budget AI 336 can, for example, analyze data such as the amount spent by a user during the previous month 340, the amount that the user spent during the current month in previous years 342, and the amount that the user has spent this month so far 344. Budget AI 336 can use the amount the user has spent this month so far both for its predictive value and also to serve as a baseline for the user's monthly budget, for example to allow the user to request information regarding an amount the user is likely to spend during the remainder of the month or over the course of the entire month.

Budget AI 336 can also analyze, for example, Like Me User Data 346, in relation to which it can employ pattern recognition to determine patterns among similar users, in relation to one or both of a relevant time period or a relevant geographic location.

Budget AI 336 can also analyze Price Surge by Time and Location 348, in conjunction with, or independently from, Other Data Sources 352, to determine if local (both geographically and temporally) price surges or decreases will have an effect on a user's predicted budget, and if so, what effect those price surges or decreases might have.

Budget AI 336 can also analyze Seasonal Spent 350, which can represent one or more seasonal patterns in spending. For example, if a user has, on one or more occasions or over one or more time periods, spent a certain average, minimum or maximum amount on, for example, a vacation, or on dining, within a certain relevant seasonal time period, Budget AI 336 can account for that spending as Seasonal Spent 350, and can factor that information, based on timing and other relevant spending, into the Predicted Budget 326. Seasonal Spent 350 can also contain relevant information regarding peer spending during that relevant seasonal time period, as well as the transaction data of users whose transaction data contains relevant similarities to the subject user, even if those users are not associated with a subject user by a particularly high Like Me Score 332. For example, Seasonal Spent 350 can include information related to users' seasonal spending before Christmas, or during the months of February and May, and can include further details regarding that spending, such as that “before Christmas” spending is more closely associated with frequent and/or high value spending at retail stores, while increased spending in February and May are more closely associated with purchases of flowers. Budget AI 336 can therefore use seasonal and/or micro-geographical price changes across different merchants and/or merchant categories of spending to identify potential changes in the user's future spending.

Budget AI 336 can output a Predicted Budget 326, which can contain input and output data of a user, such as an amount spent on one or more categories of merchant and a predicted amount that the user will spend within a projected time period into the future.

In some embodiments, the Enrollment/Profile Engine 210 can maintain user information, for example demographic information, and any other information voluntarily provided by user based on optional survey questions.

In some embodiments, Data source 206 can provide third party data to the Spending Behavior Analysis Engine 214. In some embodiments, the third-party data can include SKU-level detail from transactions. For example, Data source 206 can provide data regarding a user's $400 purchase at a certain merchant, as well as data indicating the specific breakdown of that user's transaction, e.g. indicating that within that transaction, $20 were spent on beach chairs, $40 were spent on children's toys, $100 was spend on a cooler, $140 were spent on a barbecue grill, $40 were spent on charcoal, and $60 were spent on groceries.

In some embodiments, such data can also include social media data, which can also be used to identify a user's peers. For example, potential peers of a user can be identified by the Spending Behavior Analysis Engine 214 upon receiving an indication of a user's friends on social media. In some embodiments, Data source 206 can also provide specific social media data, including data related to a user's social media habits. In some embodiments, Spending Behavior Analysis Engine 214 can compare social media data of a user with social media data of other users to determine one or more peer groups of the user. For example, and not limitation, users connected to the user who tag pictures on social media at the same restaurants as the user can be considered peers.

In some embodiments, Data source 206 can include any other data source indicating user info, including, for example and not limitation, data related to payments, purchases, activities, events, social media data, metadata associated with transactions and payment devices, and other data made available, either by a user or through a third-party source connected to a user.

In some embodiments, User Equipment 202 can comprise a computing device associated with a user. The computing device can, for example, be a mobile computing device, such as a cell phone, tablet, or laptop computer. The computing device can, for example, be any computing device used to access the internet. In some embodiments, the User Equipment 202 can also be a computing device used to make payments, such as, for example, using Near-Field Communication technology, radio frequency, and/or other forms of wireless communication protocols.

In some embodiments, the Transaction Interface 204 can be an eWallet system, which can allow users to access digital payment methods and complete transactions with merchants Transaction Interface 204 can provide an interface between User Equipment 202 and the Predictive Analysis Engine 212.

In some embodiments, User Detail 216 can store data related to user information. Such information can include information collected directly from users, such as information collected through optional survey questions and demographic information associated with one or more user accounts. User Detail 216 can also store information that is the result of the analysis of other information, such as from the outputs of the Spending Behavior Analysis Engine 214 or the Predictive Analysis Engine 212.

In some embodiments, User Detail 216 can include User Profile 216a and Proposed Budget 216b. As discussed above, in some embodiments, User Profile 216a can include basic user data such as demographic information and the answers to user-directed survey questions. In some embodiments, User Profile 216a can include complex results of analyzed user data, including information related to identified peer groups of a user, the user's spending on various types of purchases in relation to other users within one or more peer groups of that user, and one or more predictions of that user's future spending activity. Proposed Budget 216b can include a system-generated or user-defined proposed budget. Such a proposed budget can also be created using a combination of user inputs and system outputs from the Spending Activity Analysis/Prediction System 208 that incorporates one or more predicted future spending activity.

In some embodiments, Transaction Data Repository 218 can be configured to receive and transmit data to/from Spending Behavior Analysis Engine 214. Such data can include third party data from Data source 206 and can also include transformed data output by the Spending Behavior Analysis Engine 214, which can include information related to identified peer groups of a user and the user's spending on various types of purchases in relation to other users within one or more peer groups of that user. In some embodiments, Transaction Data Repository 218 can transmit data to the Spending Behavior Analysis Engine 214 for processing. In some embodiments, Data Warehouse 220 can store information from Transaction Data Repository 218.

As embodied herein, the Spending Activity Analysis/Prediction System 208, including the Enrollment/Profile 210, the Predictive Analysis Engine 212, and the Spending/Behavior Analysis Engine 214, and their sub-components and sub-processes can be embodied in a single configuration, or various multiple configurations of processing circuitry. In some embodiments, Enrollment/Profile 210, the Predictive Analysis Engine 212, and the Spending/Behavior Analysis Engine 214 and their sub-components and sub-processes can comprise processing circuitry at one physical location or in more than one, or various different physical location.

In alternative embodiments, the components of the described system for predicting future spending may comprise processing circuitry in one or several physical locations configured to operate as described via application program interfaces (API's).

FIG. 5 is a flow chart illustrating a representative method 500 implemented according to an illustrative embodiment of the disclosed subject matter. The exemplary network 100 of FIG. 1 and system 200 of FIG. 2, for purpose of illustration and not limitation, are discussed with reference to the exemplary method of FIG. 3.

As embodied herein, at 502, the Spending Behavior Analysis Engine 214 can receive at least one data point of a user, which can include a transaction attribute or transaction attributes. Transaction attributes can include transaction metadata, such as, for example, time, location, and payment method information for a transaction. The at least one data point of a user can also include SKU-level detail from transactions. The at least one data point of a user can also include social media data associated with the user and/or social media data associated with other users. The at least one data point can also include demographic information input by the user or received from third party data sources. The at least one data point can also include results of data processes as described herein with respect to system 200, such that system 200 can use its own outputs as inputs in combination with any other types of data. Such data can, for example, be received by the processing circuitry of the Spending Behavior Analysis Engine 214 from Data source 206, which can include any available data, both internally and from third party systems and networks.

At 504, the Spending Behavior Analysis Engine 214 can analyze the at least one data point. In some embodiments, analyzing the at least one data point can include grouping and categorizing data, such as by Classification Process 300. For example, the Spending Behavior Analysis Engine 214 can rank the number, and/or the frequency, of a user's transactions based on the geographic location of the transaction, or the specific merchant, or the type of merchant For example, at step 504, the Spending Behavior Analysis Engine 214 can rank the top 5 geographic locations at which the user made transactions, by, for example, the number of transactions and/or the total amount of the transactions.

In some embodiments, at step 504, the Spending Behavior Analysis Engine 214 can analyze a user's spending habits across categories of merchant or across categories of items purchased.

In some embodiments, the Spending Behavior Analysis Engine 214 can perform the analysis of step 504 and can transmit the results of that analysis to the Transaction Data Repository 218, and/or to the Predictive Analysis Engine 212, where such analyzed/transformed data can be further processed by the system.

In some embodiments, at step 504, the Spending Behavior Analysis Engine 214 can identify the location of a merchant and the distance between the user's home and the location of a merchant associated with a transaction or transactions. In some embodiments, this step can include recording how much money a user spent, at which merchants, on which items, and at what frequency.

In some embodiments, at step 504, Spending Behavior Analysis Engine 214 can create a user profile based on the received data associated with a user and the results of analyzing that data. In some embodiments, the metadata associated with the user transactions relating to date and time of the transactions can be added to a user's user profile.

At 506, the Spending Behavior Analysis Engine 214 can determine at least one peer group of the user based in part on the at least one data point.

In some embodiments, for example, and not limitation, at step 506, Spending Behavior Analysis Engine 214 can group users whose demographic information indicates that they live within a certain distance from each other, and whose transaction data indicates that they make transactions with at least one same merchant In some embodiments, at step 506, Spending Behavior Analysis Engine 214 can determine the level of similarity among users within an identified peer group, such as by analysis process employed by Like Me Score Generator 328. For example, users who live very close to each other and shop at many of the same stores can define a closely related peer group, whereas users who occupy a large city and share only a few common merchants can define a more loosely related peer group. Such peer groups can be categorized by a percentage evaluation or a score describing the closeness of the similarity or match among users within that peer group. For example, and not limitation, a percentage evaluation could range from 0% to 100%, or a score could range from 0-10, and/or a score could be language based, with scores assigned ranging from “Low” to “Medium” to High,” or a specific, number-based percentage evaluation or score could be assigned, with a corresponding language-based score explaining the number-based percentage evaluation or score.

In some embodiments, at step 506, Spending Behavior Analysis Engine 214 can use demographic information in addition to transaction history to determine a peer group of a user, and can use one or more user-directed questions to gather data related to a user's demographic information. In some embodiments, at step 506, Spending Behavior Analysis Engine 214 can perform analytics based on spending patterns of a user, including the analysis of the location of transactions, the amount of money spent on each transaction at each location, and the frequency of transactions in general and at specific merchants or locations.

In some embodiments, at step 506, Spending Behavior Analysis Engine 214 can draw inferences based on a user's transaction history. For example, and not limitation, a user's transactions can be analyzed and inferences regarding the user's family or living situation can be drawn. For example, at step 506, Spending Behavior Analysis Engine 214 can draw inferences based on a user's transaction history indicating the user purchased a certain amount or types of grocery items at a certain frequency, as well as that the user purchased children's clothing, and that the user purchased gasoline regularly at two different locations. In this example, at step 506, Spending Behavior Analysis Engine 214 can draw the inferences that the user lives with a family, including at least one child, and perhaps more than one car. Step 506 can include grouping users into a peer group based on such inferred demographic data, such as in the above example.

In some embodiments, at step 506, Spending Behavior Analysis Engine 214 can define peer groups based on discrete spending habits. For example, and not limitation, a peer group can be defined based on a user's amount of spending per month on a single type of purchase, such as food, transportation, or dining. Such categorical transaction information can be added to a user profile and the system can group users based on these categorical profiles.

In some embodiments, at step 506, Spending Behavior Analysis Engine 214 can group a user with peers having similar travel habits. For example, and not limitation, a user who frequently travels to four cities can be grouped with peers who, for example, travel frequently to those same four cities and have some similar transactions in those cities. Additionally, and/or alternatively, in this example embodiment, the user can be grouped with peer users who also travel to those same four cities but do not have any similarity among their transaction histories. Additionally, and/or alternatively, the user in that example can be grouped with peer users who frequently travel to more than three cities. In this manner, different peer groups of a user, encompassing users having potentially different levels of actual similarity with the user, can be identified.

In some embodiments, at step 506, Spending Behavior Analysis Engine 214 can include the capability to allow users to access peer group information. In some embodiments, users can access and review peer group information from User Equipment 202, and can be presented with peer group statistics on spending and statistics related to a user's spending relative to certain peer groups, within certain categories. In some embodiments, a user can run specialized queries to see at a more granular level how their peers are spending. For example, a user can filter by location or merchant/merchant-type to retrieve information related to their spending relative to the spending of peer users. In this example, a user can retrieve information in the form of bands. For example, a user's query can return the result that the user is spending, in relation to peer users, 25% of what the average user spends on a certain merchant-type. Additionally and/or alternatively, a user can retrieve information in for the form of bands indicating that a certain number of peer users share, exceed, or do not exceed, a certain user statistic. For example, a user can retrieve a band result indicating that 10-50 peer users share a certain spending statistic with the user, or that 100+ peer users share, exceed, or do not exceed a certain spending statistic with the user.

In some embodiments, at step 506, Spending Behavior Analysis Engine 214 can include identifying at least one peer group of the user by identifying other users with similar user profiles as the user. In some embodiments, the Spending Behavior Analysis Engine 214 can identify the level of similarity between the user's user profile and the user profiles of the users within the at least one identified peer group, and, if more than one peer group is identified, ranking the identified peer groups by level of similarity.

User data is analyzed in the aggregate and is not reported to any specific user in a format that would identify another particular user. In some embodiments, users can be informed of their relative spending in relation to one or more peer groups as a percentage above or below average or, as discussed, relative spending data can be reported in the form of bands. In some embodiments, users can be informed of the percentage of users within one or more peer groups who spend more or less than that user, for example within a certain time period. For example, and not limitation, a user may be informed that 90% of that user's peers spend more than that user or, for example, that 50% of that user's peers spend more or less than that user at restaurants every month.

At step 508, the Predictive Analysis Engine 212 can compare the at least one data point of the user with data associated with the at least one peer group of the user.

In some embodiments, the Predictive Analysis Engine 212 can compare user data with data associated with one or more users within the at least one identified peer group of the user. Such a comparison could be used by the Predictive Analysis Engine 212 to form a prediction that the user's spending will change in a manner or direction consistent with users within the identified peer group. At step 508, such comparison and analysis may be performed, in part or in full, by Budget AI 336.

In some embodiments, at step 508, the Predictive Analysis Engine 212 can compare user data with data associated with other users identified with more than one peer group that the Spending Behavior Analysis Engine 214 identifies as associated with the user. In some embodiments, the Predictive Analysis Engine 212 can generate multiple comparisons and determine the level of closeness, between the user and the users within the peer group, as to each comparison, and can form multiple predictions, or can form one prediction by using each of the more than one comparison as weighted variables.

At step 510, the Predictive Analysis Engine 212 can predict at least one future spending activity of the user.

In some embodiments, the Predictive Analysis Engine 212 can predict future spending of a user, based on an analysis of that user's current spending, including the results of analyzing user data, such as information associated with a user profile, and information known about other users within at least one peer group associated with the user.

In some embodiments, the Predictive Analysis Engine 212 can predict a future spending activity of a user by identifying a peer group of a user comprising previous user profiles of other users that are similar to the user's current user profile. By comparing current user profiles of the other users within that peer group, the system and method disclosed herein can predict at least one future spending activity of the user whose current user profile is similar to the identified peer group's users' previous user profiles. In this manner, the Predictive Analysis Engine 212 recognizes trends among the users whose previous user profiles resemble the user's current user profile, and predicts that the user will follow one or more similar trends. In some embodiments, the prediction can be based on the identified similarity between the user's user profile and the previous user profiles of the other users, as well as identified differences.

In some embodiments, the predicted future spending activity can include more than one prediction or predictions spanning several time frames, from weeks or months into the future, to years. For example, for a user who just had a child, a prediction might be formed based on a comparison to users with similar previous profiles that, in 6 months, the user will begin spending more money on clothing and food, and another prediction might be formed indicating that in 8 years, the user will begin spending more money on gasoline.

FIG. 4 is a block diagram illustrating further details of a representative computer system according to an illustrative embodiment of the disclosed subject matter.

The systems and techniques discussed herein can be implemented in a computer system. As an example, and not by limitation, as shown in FIG. 4, the computer system having architecture 400 can provide functionality as a result of processor(s) 401 executing software embodied in one or more tangible, non-transitory computer-readable media, such as memory 403. The software implementing various embodiments of the present disclosure can be stored in memory 403 and executed by processor(s) 401. A computer-readable medium can include one or more memory devices, according to particular needs. Memory 403 can read the software from one or more other computer-readable media, such as mass storage device(s) 435 or from one or more other sources via communication interface 420. The software can cause processor(s) 401 to execute particular processes or particular parts of particular processes described herein, including defining data structures stored in memory 403 and modifying such data structures according to the processes defined by the software. An exemplary input device 433 can be, for example, a keyboard, a pointing device (e.g. a mouse), a touchscreen display, a microphone and voice control interface, or the like to capture user input coupled to the input interface 423 to provide data and/or user input to the processor 401. An exemplary output device 434 can be, for example, a display (e.g. a monitor) or speakers coupled to the output interface 424 to allow the processor 401 to present a user interface, visual content, and/or audio content. Additionally or alternatively, the computer system 400 can provide an indication to the user by sending text or graphical data to a display 432 coupled to a video interface 422. Furthermore, any of the above components can provide data to or receive data from the processor 401 via a computer network 430 coupled the communication interface 420 of the computer system 400. Additionally, and/or alternatively, the computer system can provide functionality as a result of logic hardwired or otherwise embodied in a circuit, which can operate in place of or together with software to execute particular processes or particular parts of particular processes described herein. Reference to software or executable instructions can encompass logic, and vice versa, where appropriate. Reference to a computer-readable media can encompass a circuit (such as an integrated circuit (IC)) storing software or executable instructions for execution, a circuit embodying logic for execution, or both, where appropriate. The present disclosure encompasses any suitable combination of hardware and software.

In some embodiments, processor 401 includes hardware for executing instructions, such as those making up a computer program. As an example and not by way of limitation, to execute instructions, processor 401 can retrieve (or fetch) the instructions from an internal register, an internal cache 402, memory 403, or storage 408; decode and execute them; and then write one or more results to an internal register, an internal cache 402, memory 403, or storage 408. In particular embodiments, processor 401 can include one or more internal caches 402 for data, instructions, or addresses. This disclosure contemplates processor 401 including any suitable number of any suitable internal caches, where appropriate. As an example and not by way of limitation, processor 401 can include one or more instruction caches 402, one or more data caches 402, and one or more translation lookaside buffers (TLBs). Instructions in the instruction caches 402 can be copies of instructions in memory 403 or storage 408, and the instruction caches 402 can speed up retrieval of those instructions by processor 401. Data in the data caches 402 can be copies of data in memory 403 or storage 408 for instructions executing at processor 401 to operate on; the results of previous instructions executed at processor 401 for access by subsequent instructions executing at processor 401 or for writing to memory 403 or storage 408; or other suitable data. The data caches 402 can speed up read or write operations by processor 401. The TLBs can speed up virtual-address translation for processor 401. In some embodiments, processor 401 can include one or more internal registers for data, instructions, or addresses. This disclosure contemplates processor 401 including any suitable number of any suitable internal registers, where appropriate. Where appropriate, processor 401 can include one or more arithmetic logic units (ALUs); be a multi-core processor; or include one or more processors 401. Although this disclosure describes and illustrates a particular processor, this disclosure contemplates any suitable processor.

In some embodiments, memory 403 includes main memory for storing instructions for processor 401 to execute or data for processor 401 to operate on. As an example and not by way of limitation, computer system 400 can load instructions from storage 408 or another source (such as, for example, another computer system 400) to memory 403. Processor 401 can then load the instructions from memory 403 to an internal register or internal cache 402. To execute the instructions, processor 401 can retrieve the instructions from the internal register or internal cache 402 and decode them. During or after execution of the instructions, processor 401 can write one or more results (which can be intermediate or final results) to the internal register or internal cache 402. Processor 401 can then write one or more of those results to memory 403. In some embodiments, processor 401 executes only instructions in one or more internal registers or internal caches 402 or in memory 403 (as opposed to storage 408 or elsewhere) and operates only on data in one or more internal registers or internal caches or in memory 403 (as opposed to storage 408 or elsewhere). One or more memory buses (which can each include an address bus and a data bus) can couple processor 401 to memory 403. Bus 440 can include one or more memory buses, as described below. In particular embodiments, one or more memory management units (MMUs) reside between processor 401 and memory 403 and facilitate accesses to memory 403 requested by processor 401. In some embodiments, memory 403 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 403 can include one or more memories 404, where appropriate. Although this disclosure describes and illustrates particular memory, this disclosure contemplates any suitable memory.

In some embodiments, storage 408 includes mass storage for data or instructions. As an example and not by way of limitation, storage 408 can include a hard disk drive (HDD), a floppy disk drive, flash memory, an optical disc, a magneto-optical disc, magnetic tape, or a Universal Serial Bus (USB) drive or a combination of two or more of these. Storage 408 can include removable or non-removable (or fixed) media, where appropriate. Storage 408 can be internal or external to computer system 400, where appropriate. In some embodiments, storage 408 is non-volatile, solid-state memory. In some embodiments, storage 408 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 408 taking any suitable physical form. Storage 408 can include one or more storage control units facilitating communication between processor 401 and storage 408, where appropriate. Where appropriate, storage 408 can include one or more storages 408. Although this disclosure describes and illustrates particular storage, this disclosure contemplates any suitable storage.

In some embodiments, input interface 423 and output interface 424 can include hardware, software, or both, providing one or more interfaces for communication between computer system 400 and one or more input device(s) 433 and/or output device(s) 434. Computer system 400 can include one or more of these input device(s) 433 and/or output device(s) 434, where appropriate. One or more of these input device(s) 433 and/or output device(s) 434 can enable communication between a person and computer system 400. As an example and not by way of limitation, an input device 433 and/or output device 434 can include a keyboard, keypad, microphone, monitor, mouse, printer, scanner, speaker, still camera, stylus, tablet, touch screen, trackball, video camera, another suitable input device 433 and/or output device 434 or a combination of two or more of these. An input device 433 and/or output device 434 can include one or more sensors. This disclosure contemplates any suitable input device(s) 433 and/or output device(s) 434 and any suitable input interface 423 and output interface 424 for them. Where appropriate, input interface 423 and output interface 424 can include one or more device or software drivers enabling processor 401 to drive one or more of these input device(s) 433 and/or output device(s) 434. Input interface 423 and output interface 424 can include one or more input interfaces 423 or output interfaces 424, where appropriate. Although this disclosure describes and illustrates a particular input interface 423 and output interface 424, this disclosure contemplates any suitable input interface 423 and output interface 424.

As embodied herein, communication interface 420 can include hardware, software, or both providing one or more interfaces for communication (such as, for example, packet-based communication) between computer system 400 and one or more other computer systems 400 or one or more networks. As an example and not by way of limitation, communication interface 420 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 420 for it. As an example and not by way of limitation, computer system 400 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 400 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 can include any suitable communication interface 420 for any of these networks, where appropriate. Communication interface 420 can include one or more communication interfaces 420, where appropriate. Although this disclosure describes and illustrates a particular communication interface, this disclosure contemplates any suitable communication interface.

In some embodiments, bus 440 includes hardware, software, or both coupling components of computer system 400 to each other. As an example and not by way of limitation, bus 440 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 440 can include one or more buses 404, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

The foregoing merely illustrates the principles of the disclosed subject matter. Various modifications and alterations to the described embodiments will be apparent to those skilled in the art in view of the teachings herein. It will thus be appreciated that those skilled in the art will be able to devise numerous techniques which, although not explicitly described herein, embody the principles of the disclosed subject matter and are thus within its spirit and scope.

1. A method for predicting future spending activity comprising:
receiving, by processing circuitry, at least one data point of a user, wherein the at least one data point includes at least one transaction attribute of at least one user transaction;
analyzing, by the processing circuitry, the at least one data point;
determining, by the processing circuitry, at least one peer group of the user based in part on the at least one data point of the user;
comparing, by the processing circuitry, the at least one data point of the user with data associated with the at least one peer group of the user; and
predicting, by the processing circuitry, based on a comparison between the at least one peer group of the user and the at least one data point of the user, at least one future spending activity of the user.

2. The method of claim 1, wherein the at least one data point comprises at least one user answer to at least one user-directed question.

3. The method of claim 1, wherein analyzing, by the processing circuitry, the at least one data point, further comprises:
identifying, by the processing circuitry, a location of the at least one user transaction; and
determining, by the processing circuitry, a distance from the location of the at least one user transaction to a user's home.

4. The method of claim 1, wherein analyzing, by the processing circuitry, the at least one data point, further comprises:
identifying, by the processing circuitry, at least one merchant associated with the at least one user transaction.

5. The method of claim 4, further comprising:
determining, by the processing circuitry, based on the at least one data point of the user and based on results of analyzing, by the processing circuitry, the at least one data point, a user profile;
comparing, by the processing circuitry, the user profile to user profiles of other users within the at least one peer group of the user; and
determining a spending habits comparison of the user profile in relation to the user profiles of other users within the at least one peer group of the user.

6. The method of claim 5, wherein the spending habits comparison comprises a percentile rank associated with the user, indicating an amount that the user spent on a certain type of product or category of merchant within a set time period, as compared to other users.

7. The method of claim 4, wherein predicting, by the processing circuitry, at least one future spending activity of the user, further comprises:
identifying, by the processing circuitry, at least one peer group of a user comprising previous user profiles of other users; and
predicting, based on current user profiles of the other users within the at least one peer group of the user, at least one future spending activity of the user.

8. The method of claim 7, wherein the at least one future spending activity of the user includes a new category of spending or a new amount of spending.

9. The method of claim 1, wherein the at least one data point of the user comprises user demographic information.

10. A system for predicting future spending activity comprising:
processing circuitry configured to:
receive at least one data point of a user, wherein the at least one data point includes at least one transaction attribute of at least one user transaction;
analyze the at least one data point;
determine at least one peer group of the user based in part on the at least one data point of the user;
compare the at least one data point of the user with data associated with the at least one peer group of the user; and
predict, based on a comparison between the at least one peer group of the user and the at least one data point of the user, at least one future spending activity of the user.

11. The system of claim 10, wherein the at least one data point comprises at least one user answer to at least one user-directed question.

12. The system of claim 10, wherein the processing circuitry is further configured to:
identify a location of the at least one user transaction; and
determine a distance from the location of the at least one user transaction to a user's home.

13. The system of claim 10, wherein the processing circuitry is further configured to:
identify at least one merchant associated with the at least one user transaction.

14. The system of claim 13, wherein the processing circuitry is further configured to:
determine, based on the at least one data point of the user and based on results of analyzing, by the processing circuitry, the at least one data point, a user profile;
compare the user profile to user profiles of other users within the at least one peer group of the user; and
determine a spending habits comparison of the user profile in relation to the user profiles of other users within the at least one peer group of the user.

15. The system of claim 14, wherein the spending habits comparison comprises a percentile rank associated with the user, indicating an amount that the user spent on a certain type of product or category of merchant within a set time period, as compared to other users.

16. The system of claim 13, wherein the processing circuitry is further configured to:
identify at least one peer group of a user comprising previous user profiles of other users; and
predict, based on current user profiles of the other users within the at least one peer group of the user, at least one future spending activity of the user.

17. The system of claim 16, wherein the at least one future spending activity of the user includes a new category of spending or a new amount of spending.

18. The system of claim 10, wherein the at least one data point of the user comprises user demographic information.
